(19) United States
(12) Patent Application Publication
(10) Pub. No.: US 2008/0170355 A1
(43) Pub. Date: Jul. 17, 2008

(54) Container for multiple household electronic charging compartment

(76) Inventors: Anna Kyriakides, Tenafly, NJ (US); Tracy Wallach, Closter, NJ (US)

Correspondence Address: DONALD R HEINER, 71 MT. VERNON ST., RIDGEFIELD, NJ, 07660, US

(21) Appl. No.: 11/653,460

(22) Filed: Jan. 16, 2007

(51) Int. Cl. H02B 1/26

(52) U.S. Cl. 361/626

(57) ABSTRACT

A case or carrier for accommodating a plurality of electronic devices to be charged either singularly or more than one at a time. A slide out drawer carries a power panel which has a power surge protector. Each section of the case or carrier is removable and adjustable to change the width of each compartment to accommodate the size of the device being charged.

### BACKGROUND OF THE INVENTION

### Field of the Invention

The present invention generally involves the field of technology pertaining to a container or storage device for receiving and electrically charging multiple electric or electronic devices such as cell phones, iPods, MP3's, GameBoys, PSP's, digital cameras, and other devices that need charging from time to time. This device which will be called a “Charge Garage” can be easily carried from place to place as needed.

As already suggested, this container or carrying case or housing may accommodate a plurality of either the same electronic devices or various electronic devices all at the same time. The housing comprises multiple removable and adjustable for size compartments each with the ability to receive and charge an electronic device. Each compartment may be removed from the container or Charge Garage or housing without disturbing the other compartments and each is adjustable such that the width of each may be varied in order to accommodate each device to be charged.

Each removable-adjustable section further comprises an opening through which an electrical conduit may pass and a snap into which to attach the cord or conduit to prevent it from falling into the container or case.

In an effort to prevent overheating, the back or rear of the container or housing is preferably open while the sides of the container have a plurality of openings preferably, but not necessarily, in the shape of slots. Obviously, these openings may be of any shape.

The cover for the container or carrying case has a plurality of hinges of the type that will not allow the cover to slam shut without a force being exerted on the cover.

Each separate section has an opening which extends through the top of the device through which the power cord feeds and a snap in which to attach the cord to prevent it from slipping or sliding down into the case.

### SUMMARY OF THE INVENTION

According to the present invention, there is provided an organizer for holding and charging, individually or collectively at the same time, handheld electronic products wherein the organizer or holding device has an AC input and room for a plurality of adjustable compartments for various electronic devices that may need charging such as cell phones, iPods, MP3's, Game Boy's, PSP's, digital cameras and the like. Further, each compartment accommodates an AC adapter to connect each item to the power panel using an AC adapter for each item.

A fully integrated power panel is stored in a pull out drawer for ease of accessibility and is equipped with a power surge feature. The power panel allows for appropriate spacing to accommodate various types and styles sizes of plugs and adapters.

The outer casing accommodates a plurality of electronic devices to be charged. The container which houses virtually all of the elements comprising the invention is of generally rectangular shape having a front panel, two side panels connected to the front panel, and, an open back for reasons to be discussed below. A safety hinged cover may be disposed on the top of the organizer or case or Charge Garage. Such hinges will allow the cover to be opened to various degrees yet prevent against the cover from slamming shut.

All three of these panels, two side panels and one front panel, have vents extending there through to allow air to circulate in the container. The two side panels are sloped downwardly from back to front such that the device being charged or stored may be easily displayed when the case cover is either open or removed.

It is, therefore, an object of the present invention to provide a case for housing multiple electronic devices to be charged.

It is another object of the invention to provide such a device wherein multiple segments of a charging device may be easily removed and changed in size.

It is yet a further object of the invention to provide such a charging device which wherein electronic devices of varying types and sizes may be charged, either singularly or collectively, at the same time.

It is still a further object of the invention to provide such an electronic charging device wherein each section may be removed from a container without disturbing the other compartments.

These and other objects, features and advantages of the invention shall become apparent from the following detailed description of a preferred embodiment thereof when taken in conjunction with the drawings wherein like referenced characters refer to corresponding parts in the several views.

### BRIEF DESCRIPTION OF THE DRAWINGS

FIG. 1 is a front view of the charging device with the case cover open.

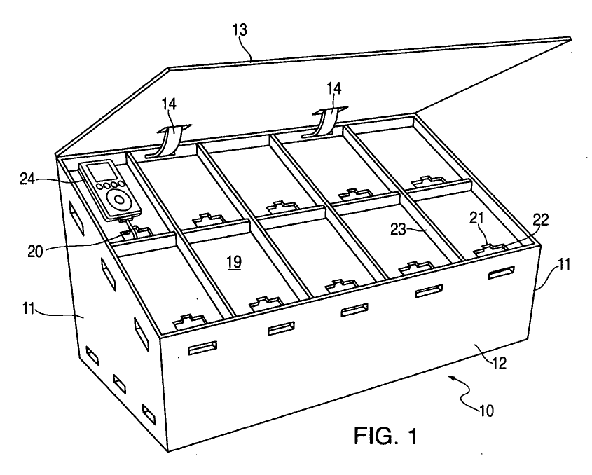

FIG. 2 is a rear view of the device of FIG. 1.

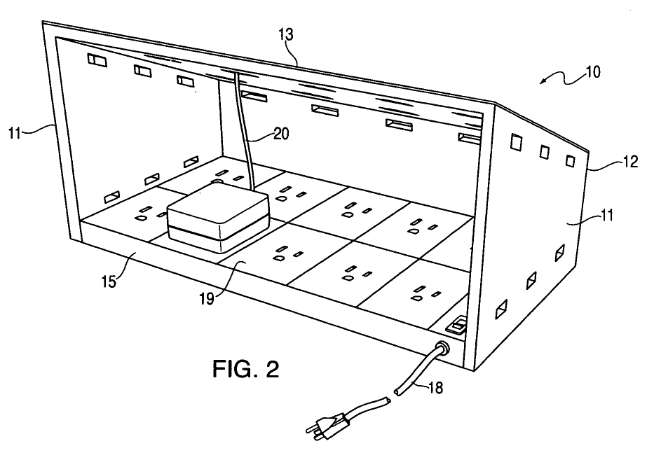

FIG. 3 is a plan view of the integrated electrical power panel with surge protector.

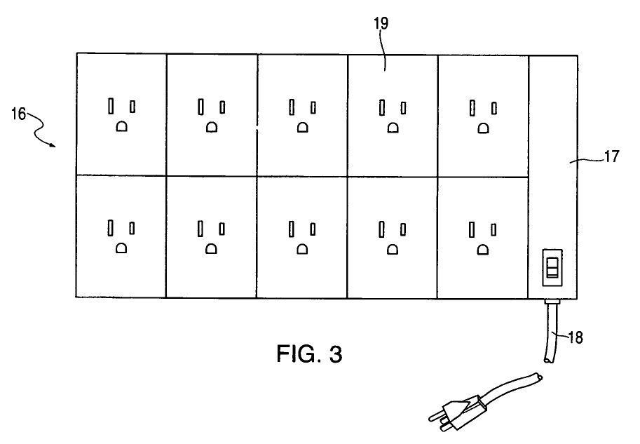

### DETAILED DESCRIPTION OF THE PREFERRED EMBODIMENT

A carrying case 10 having two side panels 111 and a front panel 12 and an open back. The two side panels slope downwardly from back to front at an angle to allow for viewing of the contents of the carrying case. A cover 13 having safety hinges 14 may be provided to close case 10. The side panels 11 and front panel 12 have slots formed there through that function to circulate air in the case 10 in conjunction with the open back.

A drawer 15 forms the bottom of case 10 and is slidable, from the open back only and houses a fully integrated power panel 16, a surge protector 17, and an electric cord 18 leading to a power source not shown.

A plurality of AC power adapter receiving sections 19, ten are shown in the drawings, are received in power panel 16 and into each section 19 and AC power adapter may be plugged for reasons to be more fully explained below. An electrical cord 20 leads from the AC power adapter in each section 19 upward through cord slots 21 where it plugs into an electronic device to be charged. The cord 20 is held firmly in place by means of a notch 21 formed in an aperture 22 in each section 19.

Each section 19 may be independently removed from the case 10 and the width of each section 19 may be altered by moving adjustable and removable dividers 23 from side to side. This will allow the device to accommodate electronic devices 24 of various sizes.

### OPERATION OF THE INVENTION

One or more electronic devises to be charged or placed into one or more segments and their cords are fed through slots and into an AC power adapter. The power adapter or charger is plugged into a power panel housed in a slide out drawer of the case. An electric cord plugged into a power source charges the AC power adapter which in turn charges the electronic device.

Though the invention has been described and illustrated with reference to a preferred embodiment thereof, those skilled in the art will appreciate that various changes and modifications in the shape, size, composition and arrangement of parts may be resorted to without departing from the spirit of the invention or scope of the subjoined claims.

What is claimed is:

1. An organizer for holding and charging electronic devices wherein said organizer has an AC input comprising:
(a) A housing;
(b) multiple removable and adjustable for size compartments in said housing each with the ability to receive and charge an electronic device:
(c) an opening in each compartment through which an electrical cord passes and a snap into which to attach said cord to prevent it from falling into said compartments;
(d) a power panel stored in a pull out drawer of said organizer; and
(e) a plurality of AC power adapters plugged into said power panel wherein one end of each of said electrical cords are plugged into each of said AC power adapters and the other end of said electrical cords are plugged into said electronic device to be charged.

2. The organizer of claim 1 wherein said housing comprises two side panels, a front panel, an open back and a drawer for accommodating said power panel.

3. The organizer of claim 2 wherein said side and front panels have a plurality of slots formed therein for circulating air in said housing.

4. The organizer of claim 3 wherein said housing has a cover having a plurality of safety hinges.

5. The organizer of claim 4 wherein said housing further houses a surge protector and an electric cord leading to a power source for housing said power panel.

6. The organizer of claim 5 wherein said power panel comprises a plurality of AC power adapters which are charged through an electric cord plugged into a power source.
